(19) United States
(12) Patent Application Publication
(10) Pub. No.: US 2007/0205313 A1
(43) Pub. Date: Sep. 6, 2007

(54) Self-Traveling Crusher

(76) Inventors: Tadashi Yagura, Tokyo (JP); Masaru Iwashita, Tokyo (JP); Seisaku Miyamoto, Tokyo (JP); Seiji Hirayama, Hyogo (JP)

Correspondence Address: MCGINN INTELLECTUAL PROPERTY LAW GROUP, PLLC, 8321 OLD COURTHOUSE ROAD, SUITE 200, VIENNA, VA, 22182-3817, US

(21) Appl. No.: 10/594,968

(22) PCT Filed: Mar. 8, 2005
(86) PCT No.: PCT/JP05/04408

§ 371 Date: Sep. 29, 2006

(30) Foreign Application Priority Data
Mar. 31, 2004 (JP) 2004-102283

(51) Int. Cl. B02C 23/00

(52) U.S. Cl. 241/36

(57) ABSTRACT

A self-traveling crusher which enables a worker to easy carry out the operation for removing the reinforcing bars that are entangling, jamming and staying between a crushing device and a discharge conveyer relying on a simple structure without transferring the crushing device to an upper part of the machine body. The self-traveling crusher comprises a hopper into which a material to be crushed will be thrown, a crushing device for crushing the material to be crushed that is thrown in, and a discharge conveyer which is positioned at an end on one side thereof under the crushing device and is extending on the other end side thereof outward of the machine to deliver the crushed material to a predetermined height, wherein the discharge conveyer is mounted on the machine body so as to swing up and down with an end on the side of the crushing device as a center, and is supported at an end on the other side thereof by the machine body via lifting means.

### FIELD OF THE INVENTION

The present invention relates to a self-traveling crusher and, more specifically, to a self-traveling crusher which allows easy removal of reinforcing bars that remain in the machine body in conducting the crushing of concrete masses.

### BACKGROUND ART

A self-traveling crusher includes, mounted on an under carriage, a hopper into which the material to be crushed will be thrown, a crushing device for crushing the material that is thrown into a predetermined size, and a discharge conveyer arranged under the crushing device and for delivering the crushed material that has fallen thereon in decreased sizes out of the machine (see, for example, patent document 1).

The self-traveling crusher is transported by using a truck or a trailer to various sites. At the site, the self-traveling crusher moves by itself to efficiently execute the crushing work. A variety kinds of materials will be crushed, such as concrete masses produced when a building is pull down, asphalt masses produced by the construction of roads, and raw ore at a quarry.

When treating a material containing reinforcing bars such as concrete masses of a building, large reinforcing bars that are separated are removed by a worker in a stage where the concrete masses are thrown into the hopper, and relatively small reinforcing bars that have passed through the crusher, have fallen on the discharge conveyer and are conveyed, are adsorbed and removed by a magnetic separator on the discharge side of the discharge conveyer.

Under the crushing device, however, relatively large reinforcing bars tend to stay being twisted, entangled and hooked among the outlet of the crushing device, the discharge conveyer and the surrounding machine structure. When there remains a large mass of reinforcing bars, however, it becomes difficult to deliver the crushed material through the discharge conveyer and the crushing work cannot be executed.

Should that happen, the crushing work is discontinued, the crushing device and the discharge conveyer are halted, a checking window provided in the side surface of the machine body is opened though it has normally been closed, and the entangled, jammed and remaining reinforcing bars are melt-cut by using a burner, or are cut and removed by using a wire cutter by utilizing the window.

On the site of operation, the removing work must be carried out through the checking window in a narrow space in the self-traveling crusher requiring extended periods of time and cumbersome work. To facilitate the removal of reinforcing bars, a self-traveling crusher has been developed according to which the crushing device is installed on the machine at a high position to form a working space enabling a worker to enter into between the outlet of the crushing device and the discharge conveyer (see patent document 1).

Patent document: JP-A-2000-325819 (FIGS. 2 and 6)

### DISCLOSURE OF THE INVENTION

In the conventional self-traveling crusher of the form described above, however, it is desired to make a further improvement concerning the removal of reinforcing bars that remain in the machine body. Namely, it is not easy to remove the reinforcing bars through the checking window of the machine body while an increased cost is required if it is attempted to provide a working space for a worker between the crushing device and the discharge conveyer by transferring the crushing device to an upper position of the machine. Besides, the traffic regulations impose a limitation on the height when the self-traveling crusher is transported by using a trailer. Even if a space is provided, therefore, its size is small merely permitting the worker to enter therein lying on his belly and, still, the work for removing the reinforcing bars is not easy.

The present invention was accomplished in view of the above-mentioned facts, and its technical problem is to provide a self-traveling crusher which enables a worker to easy carry out the operation for removing the reinforcing bars that are entangling, jamming and staying between the crushing device and the discharge conveyer relying on a simple structure without transferring the crushing device to an upper part of the machine body.

The present inventors have forwarded keen study, gave attention to the structure for installing the discharge conveyer, and have developed a self-traveling crusher which enables the lower side of the crushing device to be easily accessible by the worker relying on a simple structure.

In order to solve the above-mentioned technical problems according to the present invention, there is provided a self-traveling crusher comprising a hopper into which a material to be crushed will be thrown, a crushing device for crushing the material to be crushed that is thrown in, and a discharge conveyer which is positioned at an end on one side thereof under the crushing device and is extending on the other end side thereof outward of the machine to deliver the crushed material to a predetermined height, which are all mounted on a machine body having an under carriage, wherein the discharge conveyer is mounted on the machine body so as to swing up and down with an end on the side of the crushing device as a center, and is supported at an end on the other side thereof by the machine body via lifting means.

Desirably, provision is made of holding means for releasably holding the discharge conveyer at a predetermined lifted position, the holding means including a hook member attached to the machine body so as to rotate and a shaft member provided on the discharge conveyer that is releasably held by the hook member. Further, the lifting means includes a hydraulic cylinder that can be expanded and contracted, and the lifting means and engaging means are, respectively, attached to a magnetic selector support frame which is mounted on the machine body and from which a magnetic selector is hanged down on the discharge side of the discharge conveyer at an upper position thereof.

In the self-traveling crusher constituted according to the present invention, the discharge conveyer is positioned at an end on one side thereof under the crushing device that delivers the crushed material, extends on the other end side thereof outward of the machine body to a predetermined height, swings in the up-and-down direction of the machine body with the end side of the crushing device as a center, and is supported on the other end side thereof by the machine body via the lifting means. By lowering the discharge conveyer extending up to a predetermined height from the side of the crushing device down to, for example, ground by using the lifting means with the side of the crushing device as a center, therefore, a space can be formed between the machine body mounting the crushing device and the discharge conveyer permitting easy access by a worker from the outer side of the machine body. Therefore, reinforcing bars staying under the crushing device can be easily removed by utilizing the space.

The conventional discharge conveyer is mounted on the machine so as to swing up and down with the end thereof on the side of the crushing device as a center without basically changing the position of the discharge conveyer, and lifting means is provided on the other end side thereof. Therefore, the structure is simple, the crushing device does not have to be transferred to the upper part of the machine body, the cost of production is cheap, and the height of the machine body does not increase.

### BRIEF DESCRIPTION OF THE DRAWINGS

FIG. 1 is a view illustrating the constitution of a self-traveling crusher according to the present invention;

FIG. 2 is a view illustrating, on an enlarged scale, a portion of a discharge conveyer on the discharge side in FIG. 1;

FIG. 3 is a view illustrating, on an enlarged scale and in detail, a portion of holding means of FIG. 2;

FIG. 4 is a view illustrating a hook member of FIG. 3 on an enlarged scale and in detail; and

FIG. 5 is a view illustrating a hook member-mounting portion of FIG. 3 on an enlarged scale and in detail.

### BEST MODE FOR CARRYING OUT THE INVENTION

The self-traveling crusher constituted according to the present invention will be described in further detail with reference to the accompanying drawings that illustrate a preferred embodiment.

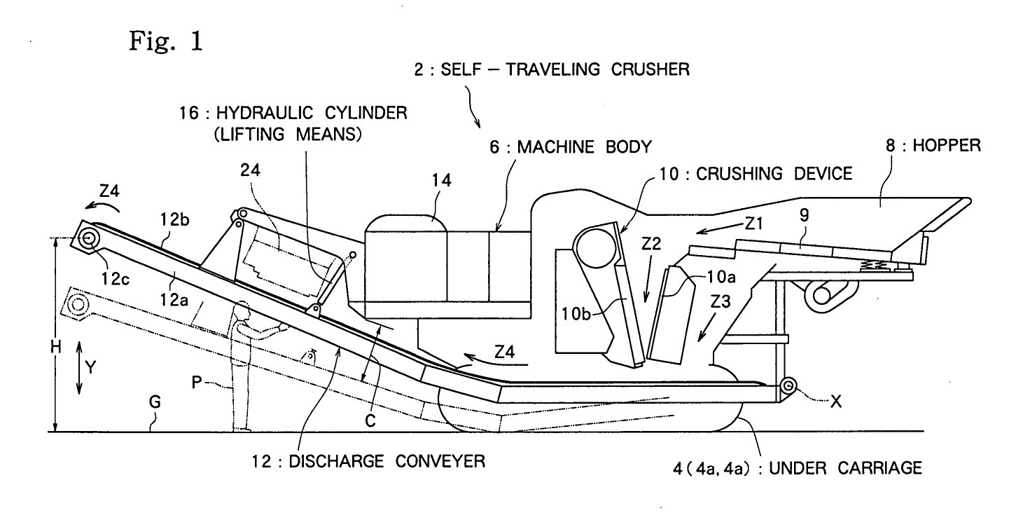

Reference is now made to FIG. 1 which is a view illustrating the constitution of the self-traveling crusher. The self-traveling crusher generally designated at 2 includes a hopper 8 into which a material to be crushed will be thrown, a crusher device 10 for crushing the material to be crushed that is thrown in, and an endless discharge conveyer 12 positioned under the crushing device 10 and is extending from the side of the crushing device 10 outward of the machine 6 to deliver the crushed material to a predetermined height H, which are all mounted on a machine body 6 that has a crawler-type under carriage 6. The under carriage 4 has a pair of traveling tracks 4a and 4a in the direction of width of the machine body 6 (in the direction perpendicular to the surface of the paper in FIG. 1), and the discharge conveyer 12 passes through between the traveling tracks 4a and 4a. A power unit 14 containing a power source such as an engine is provided at an end of the machine body 6 on the side opposite to where the hopper 8 is provided.

The discharge conveyer 12 is mounted on the machine body 6 at an end thereof on the side of the crushing device 10 so as to swing up and down (in a direction indicated by an arrow Y in FIG. 1) relative to the machine body 6 with an axis X extending in the direction of width of the machine body 6 (in the direction perpendicular to the surface of the paper in FIG. 1) as a center. The discharge conveyer 12 is supported on the discharge side thereof by the machine body 6 via a hydraulic cylinder 16 which is lifting means.

The under carriage 4, hopper 8, crushing device 10 and power unit 14 are not to constitute a novel feature of the present invention, and may be those of the known ones. Therefore, they are not described in detail. Further, the discharge conveyer 12 itself may be the known one, but a novel feature of the present invention resides in the method of its mounting on the machine body 6 as will be described later in detail.

In the self-traveling crusher 2, a material to be crushed such as a concrete mass thrown into the hopper 8 is sent (arrow Z1) to a throw port at an upper part of the crushing device 10 by a feeder 9 equipped with a vibration-sieving device. The material to be crushed thrown into the crushing device 10 is crushed as it is caused to pass through (arrow Z2) between a pair of fixed tooth 10a and moving tooth 10b arranged in a V-shape in a manner that the lower outlet side is narrow, to thereby form a crushed material of a predetermined size defined by the gap of the outlet. The crushed material falls down from the outlet of the crushing device 10 onto the discharge conveyer 12 together with fine pieces (arrow Z3) falling through the vibration-sieve of the feeder 9, and is delivered (arrow Z4) by the endless discharge conveyer 12 up to a predetermined height H on the outer side of the machine body 6.

The discharge conveyer 12 includes a frame 12a that extends from the side of the crushing device 10 being curved upward toward the height H on the discharge side, an endless conveyer belt 12b wrapped round the frame 12a, and a hydraulic motor 12c provided at an end of the frame 12a on the discharge side to circularly drive the conveyer belt 12b.

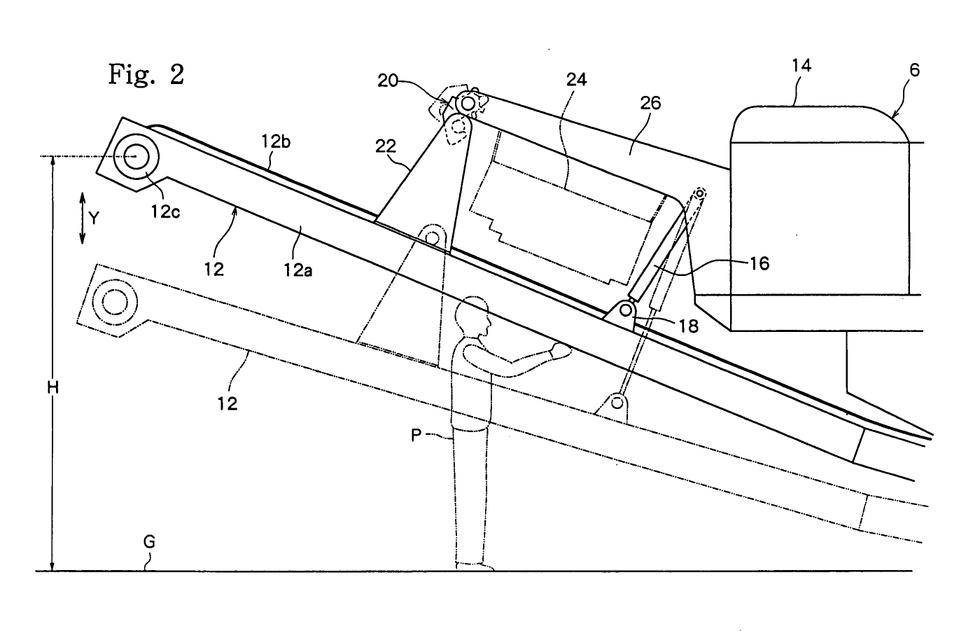

The description further goes with reference to FIG. 1 as well as FIG. 2 which is a view illustrating, on an enlarged scale, a portion of the discharge conveyer 12 on the discharge side in FIG. 1. An upwardly protruding bracket 18 to which an end of a hydraulic cylinder 16 will be attached is provided on a portion of the frame 12a extending outward beyond the machine body 6. An upwardly protruding bracket 22 forming holding means 20 is formed between the bracket 18 and the end to where the hydraulic motor 12c is attached to thereby releasably hold the discharge conveyer 12 at a predetermined height H. The brackets 18 and 22 are provided in pairs, respectively, on both sides in the direction of width of the discharge conveyer 12 (in the direction perpendicular to the surface of the paper in FIGS. 1 and 2).

A magnetic selector support frame 26 from which a known magnetic selector 24 will be hanged down is mounted at an end of the machine body 6 where the power unit 14 is provided, the magnetic selector support frame 26 being positioned over the discharge conveyer 12 and protruding outward of the machine body 6 along a direction in which the discharge conveyer 12 extends. The magnetic selector 24 adsorbs and selects reinforcing bars and metal pieces contained in the crushed material delivered by the discharge conveyer 12.

The hydraulic cylinder 16 which is lifting means is attached at one end thereof which is the head side to a proximal end the magnetic selector support frame 26 on the side of the power unit 14, and is attached at the other end thereof which is the rod side to the bracket 18 of the discharge conveyer 12. The hydraulic cylinders 16 are provided in a pair on both sides of the discharge conveyer 12 in the direction of width thereof so as to be corresponded to the pair of brackets 18.

The hydraulic cylinder expands and contracts due to the compressed fluid from the power unit 14. Due to this expanding/contracting motion, the discharge conveyer 12 swings in the up-and-down direction Y with the axis X on the side of the crushing device 10 as a center between an upper position where the end thereof on the discharge side assumes a height H as represented by a solid line and a lower position represented by a two-dot chain line.

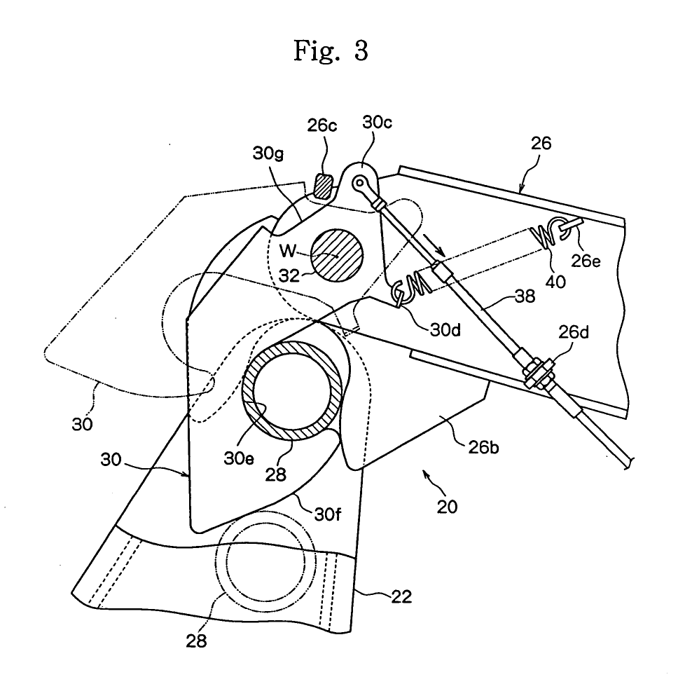

Holding means 20 will now be described with reference to FIGS. 1 and 2 together with FIGS. 3 to 5 and, chiefly, with reference to FIG. 3. The holding means 20 includes a pipe 28 which is a shaft member arranged at an upper portion of the bracket 22 of the discharge conveyer 12 and is extending in the direction of width of the machine body 6, and a hook 30 attached to the shaft 32 so as to rotate about an axis W at an end of the magnetic selector support frame 26 extending in the direction of width of the machine body 6. The pipe 28 is releasably held by the hooks 30.

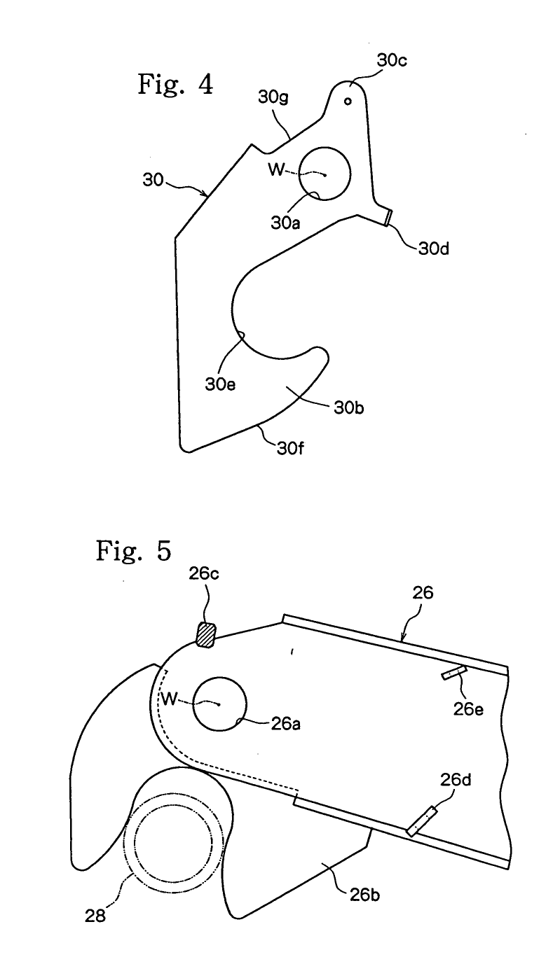

The hook will now be described with reference chiefly to FIG. 4. The hook 30 is formed by punching a thick plate member, and includes a bearing hole 30a formed in one end thereof with the axis W as a center and a J-shaped hook portion 30b formed at the other end thereof. On the outer side of the bearing hole 30a in the radial directions, there are formed a bracket 30c for attaching an operation cable and a bracket 30d for attaching a spring. On the outer side of the bearing hole 30a in the radial direction, a groove portion 30g is formed extending in the circumferential direction to limit the range of turn with the axis W of the hook 30 as a center. The J-shaped recessed portion 30e of the hook portion 30b is formed in a size that engages with the pipe 28, and a tilted portion 30f is formed on the J-shaped outer side gradually extending outward in the radial direction with the axis W as a center from an end of opening of the recessed portion 30e.

Reference is made chiefly to FIG. 5. The magnetic selector support frame 26 has a bearing hole 26a formed in an end portion thereof with the axis W as a center, a guide 26b having a U-shaped recessed portion for guiding the engagement with the pipe 28 of the bracket 22 of the discharge conveyer 12, a stopper 26c which comes in contact with the groove portion 30g to limit the turn of the hook 30, a bracket 26d for attaching an operation cable, and a bracket 26e for attaching a spring.

If described with reference chiefly to FIG. 3, a push-pull cable 38 supported by the bracket 26d of the magnetic selector support frame 26 is coupled at its one end to the bracket 30c for attaching the operation cable of the hook 30, and the other end of the push-pull cable 38 is coupled to an operation lever (not shown) provided on the machine body 6. A tension spring 40 is attached between the bracket 30d for attaching the spring of the hook 30 and the bracket 26e of the magnetic selector support frame 26. Due to the tension spring 40, the hook 30 is urged in a direction (counterclockwise direction) in which the J-shaped recessed portion 30e of the hook portion 30b comes in contact with the pipe 28 of bracket 22 of the discharge conveyer 12.

To bring the holding means 20 into engagement, the hydraulic cylinder 16 (FIG. 2) in the lifting means is contracted to lift up the discharge conveyer 12. Then, the pipe 28 comes in contact with the tilted portion 30f (as represented by a two-dot chain line FIG. 3) of the hook 30, turns the hook 30 clockwise against the force of the tension spring 40, and comes into engagement with the recessed portion 30e. The engaged state is reliably maintained by the J-shaped recessed portion 30e of the hook portion 30b and by the force of the tension spring 40. In this state, the discharge conveyer 12 is maintained at the height H (state represented by the solid line in FIGS. 1 and 2).

To release the engagement of the holding means 20, the push-pull cable 38 is pulled (in a direction of an arrow). The hook 30 is, then, turned in a direction in which it can be released (clockwise direction) indicated by a two-dot chain line from a position where the hook 30 had engaged with the pipe 28 against the force of the tension spring 40, and is disengaged. In this state, the hydraulic cylinder 16 in the lifting means is extended to lower the discharge conveyer 12 down to ground G (state represented by a two-dot chain line in FIGS. 1 and 2).

The pipe 28 and hook 30 in combination of the holding means 20 are provided on both sides of the discharge conveyer 12 in the direction of width, respectively. By coupling the hooks 30 together by using a member (not shown) extending in the direction of width, however, the push-pull cable 38 and the tension spring 40 may be provided on one side only.

The action of the above-mentioned self-traveling crusher 2 will now be described with reference chiefly to FIG. 1.

Reinforcing Bars can be Easily Removed:

The discharge conveyer 12 is positioned at an end on one side thereof under the crushing device 10, extends on the other end side thereof outward of the machine body 6 to a predetermined height H, swings in the up-and-down direction Y of the machine body 6 with the axis X at an end of the crushing device 10 as a center, and is supported on the other end side thereof by the machine body via the lifting means 16. By lowering the discharge conveyer 12 down to, for example, ground G by the lifting means 16 with the side of the crushing device 10 as a center, an opening of a height C (height C is 800 to 1000 mm in a typical example of FIG. 1) is formed under the front end of the power unit 14 of the machine body 6 on the side of the discharge conveyer 12. This forms a space enabling a worker P to enter therein through the opening as an inlet to make an access up to a portion where the crushing device 10 is located. The space facilitates the work for removing the reinforcing bars remaining under the crushing device 10.

In case the self-traveling crusher 2 has come into a halt due to the jamming of reinforcing bars, the self-traveling crusher 2 can be brought back to work again after a minimum of interruption of the crushing work on the site of crushing.

The Structure is Simple and there is no Additional Increase in the Height of the Machine Body:

The discharge conveyer 12 which is substantially the same as the conventional one is mounted on the machine body 6 so as to swing up and down with the end X on the side of the crushing device 10 as a center, and the lifting means 16 is provided on the side of the other end thereof. Besides, the lifting means 16 can be mounted on the existing magnetic selector support frame 26. Therefore, the structure is simple, the crushing device 10 does not have to be transferred to an upper part of the machine body, the cost of production is suppressed, and there is no additional increase in the height of the machine body.

Maintenance of the Machinery is Easy:

Since the space is easily formed enabling the lower part of the crushing device 10 to be accessed by the worker, the fixed tooth 10a and the moving tooth 10b of the crushing device 10 can be easily maintained, checked, adjusted and repaired.

Height of Discharge is Adjustable:

The discharge conveyer 12 is, as required, adjusted by the lifting means 16 for its height H for discharging the crushed material.

The invention was described above in detail by way of an embodiment. Here, however, it should be noted that the invention is in no way limited to the above embodiment only but can be varied and modified in a variety of ways as, for example, described below without departing from the scope of the invention.

Holding Means:

In the above embodiment, the hook member and the shaft member are releasably combined together as holding means 20. However, any other suitable means may be employed by inserting and removing the pins in and out of the above members to accomplish the releasable engagement.

Lifting Means:

In the above embodiment, the hydraulic cylinder is provided as lifting means 16. However, any other suitable means may be employed such as winch, motor, etc. provided it is capable of moving the discharge conveyer 12 up and down.

Frame:

In the above embodiment, the lifting means 16 and the holding means 20 are mounted on the known magnetic selector support frame 26 which is provided for the machine body 6. However, there may be used a dedicated frame instead of the magnetic selector support frame 26.

Lifting Height of the Discharge Conveyer:

In the above embodiment, the discharge conveyer 12 is lowered down to ground G to form a space relative to the crushing device. However, the discharge conveyer 12 can be lowered below the ground level, e.g., can be lowered onto a pit by the lifting means 17 to create a more increased space.

1. A self-traveling crusher comprising a hopper into which a material to be crushed will be thrown, a crushing device for crushing the material to be crushed that is thrown in, and a discharge conveyer which is positioned at an end on one side thereof under the crushing device and is extending on the other end side thereof outward of the machine to deliver the crushed material to a predetermined height, which are all mounted on a machine body having an under carriage, wherein said discharge conveyer is mounted on said machine body so as to swing up and down with an end on the side of the crushing device as a center, and is supported at an end on the other side thereof by the machine body via lifting means.

2. A self-traveling crusher according to claim 1, wherein provision is made of holding means for releasably holding said discharge conveyer at a predetermined lifted position.

3. A self-traveling crusher according to claim 2, wherein said holding means includes a hook member attached to said machine body so as to rotate and a shaft member provided on said discharge conveyer that is releasably held by the hook member.

4. A self-traveling crusher according to claim 1, wherein said lifting means includes a hydraulic cylinder that can be expanded and contracted.

5. A self-traveling crusher according to claim 2, wherein said lifting means and engaging means are, respectively, attached to a magnetic selector support frame which is mounted on the machine body and from which a magnetic selector is hanged down on the discharge side of said discharge conveyer at an upper position thereof.

6. A self-traveling crusher according to claim 2, wherein said lifting means includes a hydraulic cylinder that can be expanded and contracted.

7. A self-traveling crusher according to claim 3, wherein said lifting means includes a hydraulic cylinder that can be expanded and contracted.

8. A self-traveling crusher according to claim 3, wherein said lifting means and engaging means are, respectively, attached to a magnetic selector support frame which is mounted on the machine body and from which a magnetic selector is hanged down on the discharge side of said discharge conveyer at an upper position thereof.

9. A self-traveling crusher according to claim 4, wherein said lifting means and engaging means are, respectively, attached to a magnetic selector support frame which is mounted on the machine body and from which a magnetic selector is hanged down on the discharge side of said discharge conveyer at an upper position thereof.
